(19) United States
(12) Patent Application Publication
(10) Pub. No.: US 2026/0063041 A1
(43) Pub. Date: Mar. 5, 2026

(54) TURBINE AND TURBOCHARGER

(71) Applicant: IHI Corporation, Tokyo (JP)

(72) Inventors: Koji SAKOTA, Tokyo (JP); Kenichi SEGAWA, Tokyo (JP); Taiki YOSHIZAKI, Tokyo (JP)

(73) Assignee: IHI Corporation, Tokyo (JP)

(21) Appl. No.: 19/380,095

(22) Filed: Nov. 5, 2025

Related U.S. Application Data
(63) Continuation of application No. PCT/JP2024/021519, filed on Jun. 13, 2024.

(30) Foreign Application Priority Data
Sep. 13, 2023 (JP) 2023-148583

(51) Int. Cl. F01D 9/02

(52) U.S. Cl. CPC F01D 9/02; F05D 2220/40

(57) ABSTRACT

A turbine including: a turbine impeller; a plurality of nozzle vanes placed on a radially outer side with respect to the turbine impeller; a blade shaft provided so as to be turnable integrally with each of the plurality of nozzle vanes; an annular member opposed to the plurality of nozzle vanes in the axial direction; a plurality of blade shaft holes that open in a first surface of the annular member that is opposed to the plurality of nozzle vanes, is formed apart from each other in the circumferential direction, each allows the blade shaft to be inserted into the blade shaft hole and each has a bottom surface; and an annular protruding portion that is provided on an inner peripheral side of a second surface of the annular member on a side opposite to the first surface, and protrudes in the axial direction.

### CROSS REFERENCE TO RELATED APPLICATIONS

This application is a continuation application of International Application No. PCT/JP2024/021519, filed on Jun. 13, 2024, which claims priority to Japanese Patent Application No. 2023-148583, filed on Sep. 13, 2023, the entire contents of which are incorporated by reference herein.

### BACKGROUND ART

### Technical Field

The present disclosure relates to a turbine and a turbocharger. The present application claims the benefit of priority to Japanese Patent Application No. 2023-148583 filed on Sep. 13, 2023, the contents of which are incorporated herein by reference.

### Related Art

In a turbine used for a turbocharger or the like, in some cases, a nozzle vane for adjusting the flow velocity of an exhaust gas is provided. For example, as disclosed in Patent Literature 1, a plurality of nozzle vanes are placed on a radially outer side with respect to a turbine impeller so as to be spaced apart from each other in a circumferential direction of the turbine impeller. The cross-sectional area of a flow passage formed between nozzle vanes that are adjacent to each other changes as each nozzle vane pivots. In this manner, the flow velocity of the exhaust gas flowing between the nozzle vanes that are adjacent to each other changes.

### CITATION LIST

### Patent Literature

Patent Literature 1: JP 2004-116313 A

### SUMMARY

### Technical Problem

A nozzle vane pivots integrally with a blade shaft that protrudes from the nozzle vane in an axial direction of the turbine impeller. The blade shaft is supported by an annular member that is opposed to the nozzle vane in the axial direction of the turbine impeller. When the blade shaft is inserted into and supported by a through hole formed in the annular member, a leakage flow, which is a flow of an exhaust gas leaking through the through hole, occurs. The leakage flow of the exhaust gas can be a factor that decreases the efficiency of the turbine.

The present disclosure has an object to provide a turbine and a turbocharger that are capable of preventing a leakage flow of an exhaust gas.

### Solution to Problem

In order to solve the above-mentioned problem, according to the present disclosure, there is provided a turbine including: a turbine impeller; a plurality of nozzle vanes, which are placed on a radially outer side with respect to the turbine impeller so as to be spaced apart from each other in a circumferential direction of the turbine impeller, and are each provided so as to be pivotable about a pivot axis extending along an axial direction of the turbine impeller; a blade shaft, which protrudes from each of the plurality of nozzle vanes in the axial direction, and is provided so as to be turnable integrally with each of the plurality of nozzle vanes; an annular member, which extends in the circumferential direction, and is opposed to the plurality of nozzle vanes in the axial direction; a plurality of blade shaft holes that open in a first surface of the annular member that is opposed to the plurality of nozzle vanes, the plurality of blade shaft holes being formed apart from each other in the circumferential direction, the plurality of blade shaft holes each allowing the blade shaft to be inserted into the blade shaft hole and each having a bottom surface; and an annular protruding portion that is provided on an inner peripheral side of a second surface of the annular member on a side opposite to the first surface, the annular protruding portion extending in the circumferential direction and protruding in the axial direction.

An entire area of the bottom surface of each of the plurality of blade shaft holes may be opposed to the annular protruding portion in the axial direction.

A thickness of a part of the annular member on the radially outer side with respect to the annular protruding portion may be equal to or less than a depth of each of the plurality of blade shaft holes.

In order to solve the above-mentioned problem, according to the present disclosure, there is provided a turbocharger including the above-mentioned turbine.

### Effects

According to the present disclosure, a leakage flow of an exhaust gas can be prevented.

### BRIEF DESCRIPTION OF DRAWINGS

FIG. 1 is a schematic cross-sectional view of a turbocharger according to an embodiment of the present disclosure.

FIG. 2 is a view of a first region extracted from FIG. 1.

FIG. 3 is a view of a drive ring in the embodiment as viewed from a bearing housing side.

FIG. 4 is a view of a second region extracted from FIG. 1.

FIG. 5 is an explanatory view for illustrating thermal deformation of a shroud ring and a nozzle ring.

### DESCRIPTION OF EMBODIMENTS

Now, one embodiment of the present disclosure is described with reference to the attached drawings. Dimensions, materials, and other specific numerical values shown in the embodiment are merely examples for facilitating the understanding, and do not limit the present disclosure unless otherwise specified. In the present specification and the drawings, elements having substantially the same functions and configurations are denoted by the same reference symbols, and thus redundant description thereof is omitted. Further, illustration of elements not directly related to the present disclosure is omitted.

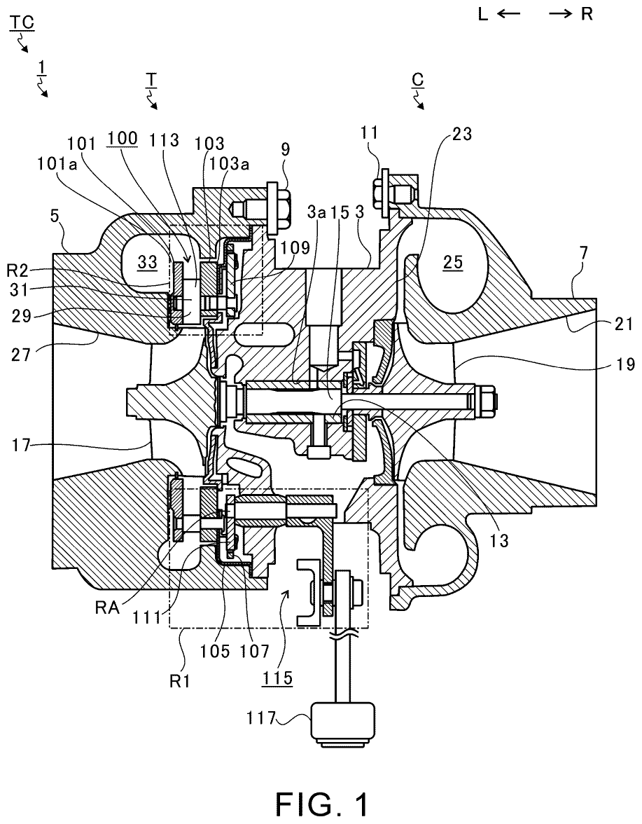

FIG. 1 is a schematic cross-sectional view of a turbocharger TC according to this embodiment. In the following, description is given assuming that a direction indicated by the arrow L illustrated in FIG. 1 corresponds to a left side of the turbocharger TC. Description is given assuming that a direction indicated by the arrow R illustrated in FIG. 1 corresponds to a right side of the turbocharger TC. As illustrated in FIG. 1, the turbocharger TC includes a turbocharger main body 1. The turbocharger main body 1 includes a bearing housing 3, a turbine housing 5, and a compressor housing 7.

The turbine housing 5 is coupled to a left side of the bearing housing 3 by a fastening bolt 9. The compressor housing 7 is coupled to a right side of the bearing housing 3 by a fastening bolt 11. The turbocharger TC includes a turbine T and a centrifugal compressor C. The turbine T includes the bearing housing 3 and the turbine housing 5. The centrifugal compressor C includes the bearing housing 3 and the compressor housing 7.

A bearing hole 3a is formed in the bearing housing 3. The bearing hole 3a penetrates the bearing housing 3 in a left-right direction of the turbocharger TC. A bearing 13 is placed in the bearing hole 3a. FIG. 1 shows a semi-floating bearing as an example of the bearing 13. However, the bearing 13 may be another bearing such as a full-floating bearing or a rolling bearing. The bearing 13 axially supports a shaft 15 in a rotatable manner. A turbine impeller 17 is provided at a left end portion of the shaft 15. The turbine impeller 17 is accommodated in the turbine housing 5 so as to be rotatable. A compressor impeller 19 is provided at a right end portion of the shaft 15. The compressor impeller 19 is accommodated in the compressor housing 7 so as to be rotatable. The turbine impeller 17 and the compressor impeller 19 rotate integrally with the shaft 15.

An axial direction, a radial direction, and a circumferential direction of the turbocharger TC are hereinafter also simply referred to as “axial direction,” “radial direction,” and “circumferential direction,” respectively. The axial direction of the turbocharger TC corresponds to an axial direction of the shaft 15, an axial direction of the turbine impeller 17, and an axial direction of the compressor impeller 19. The radial direction of the turbocharger TC corresponds to a radial direction of the shaft 15, a radial direction of the turbine impeller 17, and a radial direction of the compressor impeller 19. The circumferential direction of the turbocharger TC corresponds to a circumferential direction of the shaft 15, a circumferential direction of the turbine impeller 17, and a circumferential direction of the compressor impeller 19.

An intake port 21 is formed in the compressor housing 7. The intake port 21 opens on the right side of the turbocharger TC. The intake port 21 is connected to an air cleaner (not shown). A diffuser flow passage 23 is formed between the bearing housing 3 and the compressor housing 7. The diffuser flow passage 23 increases the pressure of air. The diffuser flow passage 23 extends in the circumferential direction and is formed in an annular shape. The diffuser flow passage 23 communicates with the intake port 21 on a radially inner side through intermediation of a space in which the compressor impeller 19 is placed.

A compressor scroll flow passage 25 is formed in the compressor housing 7. The compressor scroll flow passage 25 extends in the circumferential direction and is formed in an annular shape. The compressor scroll flow passage 25 is located, for example, on a radially outer side with respect to the compressor impeller 19. The compressor scroll flow passage 25 communicates with an intake port of an engine (not shown) and the diffuser flow passage 23.

When the compressor impeller 19 rotates, air is sucked into the compressor housing 7 from the intake port 21. The sucked air is pressurized and accelerated in the process of flowing through blades of the compressor impeller 19. The air having been pressurized and accelerated is increased in pressure in the diffuser flow passage 23 and the compressor scroll flow passage 25. The air having been increased in pressure flows out from a discharge port (not shown) and is guided to the intake port of the engine.

An exhaust port 27 is formed in the turbine housing 5. The exhaust port 27 opens on the left side of the turbocharger TC. The exhaust port 27 is connected to an exhaust gas purification device (not shown). A clearance 29 is formed between the bearing housing 3 and the turbine housing 5. A flow passage 31 through which an exhaust gas flows is formed in the clearance 29. The flow passage 31 extends in the circumferential direction and is formed in an annular shape.

A turbine scroll flow passage 33 is formed in the turbine housing 5. The turbine scroll flow passage 33 is located, for example, on the radially outer side with respect to the turbine impeller 17. The flow passage 31 is located between the turbine impeller 17 and the turbine scroll flow passage 33. The flow passage 31 allows the turbine scroll flow passage 33 and the exhaust port 27 to communicate with each other through intermediation of a space in which the turbine impeller 17 is placed.

The turbine scroll flow passage 33 communicates with a gas inflow port (not shown). An exhaust gas discharged from an exhaust manifold of the engine (not shown) is guided to the gas inflow port. The exhaust gas guided from the gas inflow port to the turbine scroll flow passage 33 is guided to the exhaust port 27 via the flow passage 31 and the blades of the turbine impeller 17. The exhaust gas guided to the exhaust port 27 in the process of flowing causes the turbine impeller 17 to rotate.

The rotational force of the turbine impeller 17 is transmitted to the compressor impeller 19 through the shaft 15. As described above, the air is increased in pressure by the rotational force of the compressor impeller 19 and is guided to the intake port of the engine.

When a flow rate of the exhaust gas introduced to the turbine housing 5 becomes smaller, a rotation amount of the turbine impeller 17 becomes smaller. When the rotation amount of the turbine impeller 17 becomes smaller, a rotation amount of the compressor impeller 19 also becomes smaller. When the rotation amount of the compressor impeller 19 becomes smaller, it may not be possible to sufficiently increase the pressure of the air to be supplied to the intake port of the engine.

In the turbine housing 5, a variable capacity mechanism 100 is provided in the clearance 29. The variable capacity mechanism 100 changes a flow passage cross-sectional area of the flow passage 31 depending on the flow rate of the exhaust gas. For example, the variable capacity mechanism 100 reduces the flow passage cross-sectional area of the flow passage 31 when the number of revolutions of the engine is low and the flow rate of the exhaust gas is small.

When the flow passage cross-sectional area of the flow passage 31 becomes smaller, the flow velocity of the exhaust gas passing through the flow passage 31 becomes faster as compared to a case in which the flow passage cross-sectional area of the flow passage 31 is large. When the flow velocity of the exhaust gas becomes faster, the rotation amount of the turbine impeller 17 becomes larger. When the rotation amount of the turbine impeller 17 becomes larger, the rotation amount of the compressor impeller 19 also becomes larger. When the rotation amount of the compressor impeller 19 becomes larger, the pressure of the air to be supplied to the intake port of the engine can be sufficiently increased. In this way, the variable capacity mechanism 100 can increase the rotation amounts of the turbine impeller 17 and the compressor impeller 19 when the flow rate of the exhaust gas is small. In the following, details of the variable capacity mechanism 100 are described.

The variable capacity mechanism 100 includes a shroud ring 101, a nozzle ring 103, a retaining member 105, a drive ring 107, a transmitting link 109, a link plate 111, a plurality of nozzle vanes 113, a drive mechanism 115, and an actuator 117. The shroud ring 101 corresponds to an example of an annular member that is opposed to the plurality of nozzle vanes 113 in the axial direction.

The shroud ring 101 is placed on a side of the clearance 29 that is farther from the bearing housing 3. The nozzle ring 103 is placed on a side of the clearance 29 that is closer to the bearing housing 3. The shroud ring 101 is placed so as to be opposed to the nozzle ring 103 in the axial direction. The shroud ring 101 is placed so as to be spaced apart from the nozzle ring 103 in the axial direction. The flow passage 31 is formed between the shroud ring 101 and the nozzle ring 103.

The shroud ring 101 has an annular shape that extends in the circumferential direction. The shroud ring 101 is placed coaxially with the turbine impeller 17. The shroud ring 101 includes a main body portion 101a having a thin-plate ring shape. The nozzle ring 103 has an annular shape that extends in the circumferential direction. The nozzle ring 103 is placed coaxially with the turbine impeller 17. The nozzle ring 103 includes a main body portion 103a having a thin-plate ring shape.

The outer diameter of the main body portion 103a of the nozzle ring 103 is approximately equal to the outer diameter of the main body portion 101a of the shroud ring 101. However, the outer diameter of the main body portion 103a of the nozzle ring 103 may be larger than or smaller than the outer diameter of the main body portion 101a of the shroud ring 101. The inner diameter of the main body portion 103a of the nozzle ring 103 is larger than the inner diameter of the main body portion 101a of the shroud ring 101. However, the inner diameter of the main body portion 103a of the nozzle ring 103 may be equal to the inner diameter of the main body portion 101a of the shroud ring 101, or may be smaller than the inner diameter of the main body portion 101a of the shroud ring 101.

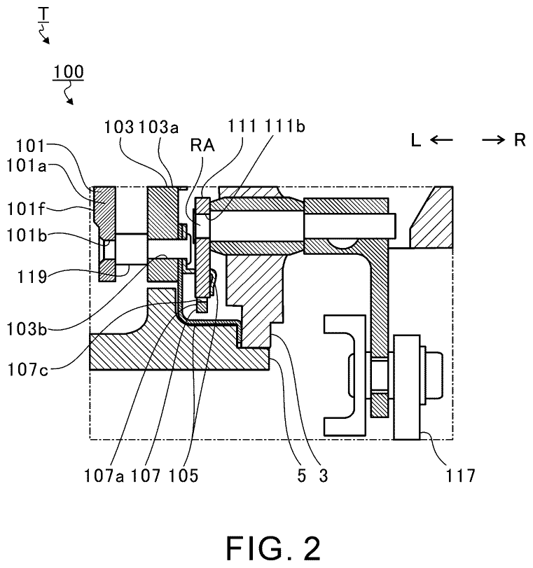

FIG. 2 is a view of a first region R1 extracted from FIG. 1. As illustrated in FIG. 2, a plurality of pin shaft holes 101b are formed in the main body portion 101a of the shroud ring 101. Each pin shaft hole 101b penetrates the main body portion 101a in the axial direction. The plurality of pin shaft holes 101b are formed to be spaced apart from each other in the circumferential direction. For example, the plurality of pin shaft holes 101b are formed at equal intervals in the circumferential direction. However, the plurality of pin shaft holes 101b may be formed at unequal intervals in the circumferential direction.

A plurality of pin shaft holes 103b are formed in the main body portion 103a of the nozzle ring 103. Each pin shaft hole 103b penetrates the main body portion 103a in the axial direction. The plurality of pin shaft holes 103b are formed to be spaced apart from each other in the circumferential direction. For example, the plurality of pin shaft holes 103b are formed at equal intervals in the circumferential direction. However, the plurality of pin shaft holes 103b may be formed at unequal intervals in the circumferential direction.

The number of the pin shaft holes 101b matches the number of the pin shaft holes 103b. Each pin shaft hole 101b is opposed to each pin shaft hole 103b in the axial direction. That is, each pin shaft hole 101b is formed coaxially with each pin shaft hole 103b. A coupling pin 119 is inserted into the pin shaft hole 101b and the pin shaft hole 103b. The shroud ring 101 is coupled to the nozzle ring 103 by the coupling pin 119. The distance between the shroud ring 101 and the nozzle ring 103 is basically kept constant by the coupling pin 119. However, as described later, the shroud ring 101 and the nozzle ring 103 may be deformed due to a temperature change caused by heat.

The retaining member 105 is placed between the nozzle ring 103 and the bearing housing 3. The retaining member 105 is coupled to the nozzle ring 103 by the coupling pin 119. In the example of FIG. 2, the retaining member 105 includes two ring-shaped thin plates joined to each other. However, the retaining member 105 may include a single ring-shaped thin plate, or may include three or more ring-shaped thin plates joined to each other.

An outer peripheral edge of the retaining member 105 is sandwiched between the turbine housing 5 and the bearing housing 3. The retaining member 105 is held non-rotatably between the turbine housing 5 and the bearing housing 3. The retaining member 105 retains the shroud ring 101 and the nozzle ring 103 non-rotatably. The drive ring 107 is placed between the nozzle ring 103 and the bearing housing 3. The retaining member 105 retains the drive ring 107 so as to be relatively rotatable.

The drive ring 107 has an annular shape that extends in the circumferential direction. The drive ring 107 is placed coaxially with the turbine impeller 17. The drive ring 107 is provided on a side opposite to the plurality of nozzle vanes 113 with respect to the nozzle ring 103. The drive ring 107 is provided so as to be pivotable in conjunction with the plurality of nozzle vanes 113, as described later.

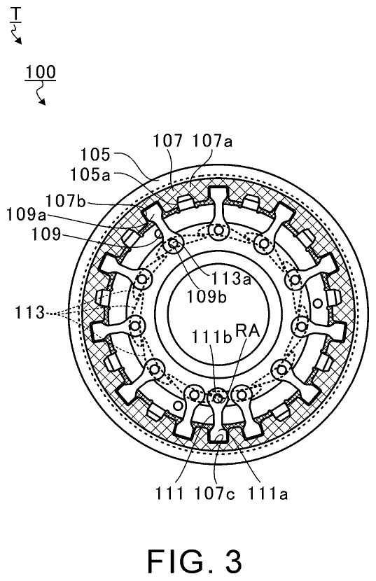

FIG. 3 is a view of the drive ring 107 as viewed from the bearing housing 3 side. As illustrated in FIG. 3, the drive ring 107 includes a main body portion 107a having a thin-plate ring shape. An inner peripheral surface of the main body portion 107a is engaged with an engagement claw 105a of the retaining member 105 so that the main body portion 107a is held so as to be pivotable relative to the retaining member 105. A plurality of transmitting link engagement portions 107b and a link plate engagement portion 107c are formed in the main body portion 107a.

The transmitting link engagement portion 107b is a portion of the main body portion 107a that is cut out from the inner peripheral surface of the main body portion 107a toward the radially outer side. The plurality of transmitting link engagement portions 107b are formed at equal intervals in the circumferential direction of the main body portion 107a. The transmitting link engagement portion 107b is engaged with an engagement end 109a of the transmitting link 109.

The link plate engagement portion 107c is a portion of the main body portion 107a that is cut out from the inner peripheral surface of the main body portion 107a toward the radially outer side. The number of the link plate engagement portions 107c is one. The link plate engagement portion 107c is formed between two transmitting link engagement portions 107b that are adjacent to each other in the circumferential direction. The link plate engagement portion 107c is engaged with an engagement end 111a of the link plate 111.

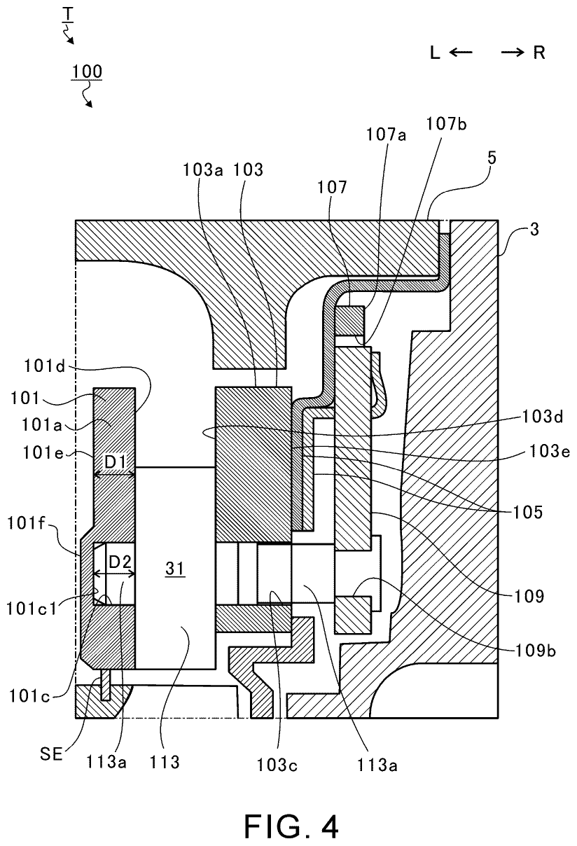

An insertion hole 109b is formed in the transmitting link 109. The insertion hole 109b is formed on a side opposite to the engagement end 109a in the transmitting link 109. As illustrated in FIG. 3 and FIG. 4 to be referred to later, a blade shaft 113a of the nozzle vane 113 is inserted into the insertion hole 109b. The transmitting link 109 is caulked under a state in which the blade shaft 113a of the nozzle vane 113 is inserted into the insertion hole 109b. The transmitting link 109 and the nozzle vane 113 pivot integrally with the blade shaft 113a.

An insertion hole 111b is formed in the link plate 111. The insertion hole 111b is formed on a side opposite to the engagement end 111a in the link plate 111. As illustrated in FIG. 2 and FIG. 3, a pivot shaft RA of the drive mechanism 115 is inserted into the insertion hole 111b. The link plate 111 is caulked under a state in which the pivot shaft RA of the drive mechanism 115 is inserted into the insertion hole 111b. The link plate 111 pivots integrally with the pivot shaft RA of the drive mechanism 115. However, the pivot shaft RA of the drive mechanism 115 may be welded to the insertion hole 111b of the link plate 111.

FIG. 4 is a view of a second region R2 extracted from FIG. 1. As illustrated in FIG. 4, a plurality of blade shaft holes 101c are formed in the main body portion 101a of the shroud ring 101. Each blade shaft hole 101c is formed on a radially inner side with respect to the pin shaft hole 101b in the main body portion 101a. Each blade shaft hole 101c opens in a first surface 101d of the shroud ring 101 that is opposed to the plurality of nozzle vanes 113, and has a bottom surface 101c1. The first surface 101d is a surface on the right side of the main body portion 101a. Each blade shaft hole 101c has a cylindrical shape, and extends in the axial direction. The plurality of blade shaft holes 101c are formed apart from each other in the circumferential direction. Specifically, the plurality of blade shaft holes 101c are formed at equal intervals in the circumferential direction.

A plurality of through holes 103c are formed in the main body portion 103a of the nozzle ring 103. Each through hole 103c is formed on the radially inner side with respect to the pin shaft hole 103b in the main body portion 103a. Each through hole 103c penetrates the main body portion 103a in the axial direction. The plurality of through holes 103c are formed to be spaced apart from each other in the circumferential direction. Specifically, the plurality of through holes 103c are formed at equal intervals in the circumferential direction.

The number of the through holes 103c matches the number of the blade shaft holes 101c. Each through hole 103c is opposed to each blade shaft hole 101c in the axial direction. That is, each through hole 103c is formed coaxially with each blade shaft hole 101c. The blade shaft 113a projects in the axial direction from each of surfaces on both sides in the axial direction of each nozzle vane 113. A left blade shaft 113a and a right blade shaft 113a provided for each nozzle vane 113 are placed coaxially with each other. Each blade shaft 113a has a columnar shape. Each blade shaft 113a is inserted into the blade shaft hole 101c and the through hole 103c. Each blade shaft 113a is turnably supported by the blade shaft hole 101c and the through hole 103c.

The plurality of nozzle vanes 113 are placed in the flow passage 31 so as to be spaced apart from each other in the circumferential direction. That is, the plurality of nozzle vanes 113 are placed on the radially outer side with respect to the turbine impeller 17 so as to be spaced apart from each other in the circumferential direction.

Specifically, the plurality of nozzle vanes 113 are placed at equal intervals in the circumferential direction. Each nozzle vane 113 is provided so as to be pivotable about a central axis of the blade shaft 113a integrally with the blade shaft 113a. That is, each nozzle vane 113 is provided so as to be pivotable about a pivot axis extending along the axial direction of the turbine impeller 17.

A seal ring SE is fitted between an inner peripheral portion of the shroud ring 101 and the turbine housing 5. The seal ring SE has an annular shape extending in the circumferential direction. The seal ring SE is placed coaxially with the turbine impeller 17. The seal ring SE closes a clearance between the inner peripheral portion of the shroud ring 101 and the turbine housing 5. The seal ring SE prevents an exhaust gas from leaking and flowing through the clearance between the inner peripheral portion of the shroud ring 101 and the turbine housing 5 from the flow passage 31. In the example of FIG. 4, one seal ring SE is provided. However, a plurality of seal rings SE may be stacked.

As illustrated in FIG. 1, the actuator 117 is placed outside the turbine housing 5, the bearing housing 3, and the compressor housing 7. The actuator 117 is, for example, a solenoid. The actuator 117 is coupled to the drive mechanism 115. The drive mechanism 115 converts a linear motion of the actuator 117 into a turning motion of the pivot shaft RA.

When the actuator 117 is driven, the pivot shaft RA of the drive mechanism 115 turns. When the pivot shaft RA turns, the link plate 111 pivots about a central axis of the pivot shaft RA integrally with the pivot shaft RA. When the link plate 111 pivots, the link plate engagement portion 107c is pressed in the circumferential direction of the link plate 111, and the drive ring 107 pivots about a central axis of the drive ring 107. When the drive ring 107 pivots, the transmitting link 109 is pressed in the circumferential direction by the transmitting link engagement portion 107b and pivots about a central axis of the insertion hole 109b. When the transmitting link 109 pivots, the blade shaft 113a turns integrally with the transmitting link 109. When the blade shaft 113a turns, the nozzle vane 113 pivots integrally with the blade shaft 113a.

When each nozzle vane 113 pivots, a distance between two nozzle vanes 113 that are adjacent to each other in the circumferential direction changes. When the distance between the two nozzle vanes 113 that are adjacent to each other in the circumferential direction changes, the flow passage cross-sectional area of the flow passage 31 changes. When the flow passage cross-sectional area of the flow passage 31 changes, the flow velocity of the exhaust gas flowing through the flow passage 31 changes.

The variable capacity mechanism 100 changes the distance between the two nozzle vanes 113 that are adjacent to each other in the circumferential direction by causing the plurality of nozzle vanes 113 to pivot in accordance with the flow rate of the exhaust gas. In this manner, an opening degree of the nozzle vane 113 changes. As the extending direction of the nozzle vane 113 comes closer to the circumferential direction of the turbine impeller 17, the distance between the two nozzle vanes 113 that are adjacent to each other in the circumferential direction becomes narrower, and the opening degree of the nozzle vane 113 becomes smaller. In contrast, as an angle formed by the extending direction of the nozzle vane 113 and the circumferential direction of the turbine impeller 17 becomes larger, the distance between the two nozzle vanes 113 that are adjacent to each other in the circumferential direction becomes wider, and the opening degree of the nozzle vane 113 becomes larger.

The opening degree of the nozzle vane 113 is adjustable within a range having an upper limit and a lower limit. When the nozzle vane 113 is fully closed, the extending direction of the nozzle vane 113 is closest to the circumferential direction of the turbine impeller 17, and the opening degree of the nozzle vane 113 becomes minimum. In contrast, when the nozzle vane 113 is fully open, the angle formed by the extending direction of the nozzle vane 113 and the circumferential direction of the turbine impeller 17 becomes largest, and the opening degree of the nozzle vane 113 becomes maximum. As the opening degree of the nozzle vane 113 becomes smaller, the flow passage cross-sectional area of the flow passage 31 becomes smaller.

For example, the variable capacity mechanism 100 reduces the opening degree of the nozzle vane 113 when the flow rate of the exhaust gas is small, thereby increasing the flow velocity of the exhaust gas. In this manner, the variable capacity mechanism 100 can increase the rotation amount of the turbine impeller 17 even when the flow rate of the exhaust gas is small. As a result, the variable capacity mechanism 100 can increase the rotation amount of the compressor impeller 19 even when the flow rate of the exhaust gas is small.

As illustrated in FIG. 4, in the variable capacity mechanism 100, the plurality of nozzle vanes 113 are sandwiched from both sides in the axial direction by the shroud ring 101 and the nozzle ring 103. The first surface 101d on the right side of the shroud ring 101 is opposed to the plurality of nozzle vanes 113. The first surface 101d has an annular shape. The blade shaft 113a protruding to the left from each nozzle vane 113 is inserted into and supported by the blade shaft hole 101c opening in the first surface 101d of the shroud ring 101. A surface 103d on the left side of the nozzle ring 103 is opposed to the plurality of nozzle vanes 113. The surface 103d has an annular shape. The blade shaft 113a protruding to the right from each nozzle vane 113 is inserted into and supported by the through hole 103c opening in the surface 103d of the nozzle ring 103.

As described above, in this embodiment, the blade shaft hole 101c into which the blade shaft 113a is allowed to be inserted has the bottom surface 101c1 in the shroud ring 101, which is an annular member. When a through hole penetrating the main body portion 101a in the axial direction is formed in the shroud ring 101, and the blade shaft 113a is inserted into and supported by the through hole, a leakage flow, which is a flow of an exhaust gas leaking through the through hole, occurs. Such a leakage flow of the exhaust gas may cause a decrease in the efficiency of the turbine T. Meanwhile, in this embodiment, the blade shaft hole 101c into which the blade shaft 113a is allowed to be inserted has the bottom surface 101c1, and hence such a leakage flow of the exhaust gas can be prevented. Thus, a decrease in the efficiency of the turbine T can be prevented.

In order to prevent the above-mentioned leakage flow of the exhaust gas, for example, when the blade shaft 113a is inserted into and supported by a through hole penetrating the main body portion 101a in the axial direction, it is conceivable to add a member that closes a left opening of the through hole. For example, it is conceivable to close the left opening of the through hole with a thin plate ring-shaped member placed coaxially with the shroud ring 101. In this case, the cost increases due to, for example, an increase in the number of components of the variable capacity mechanism 100 and an increase in man-hours for the assembly process. Further, time and effort for managing a clearance between the member closing the left opening of the through hole and the shroud ring 101 are additionally needed. Meanwhile, in this embodiment, such an increase in cost and the need for time and effort can be prevented.

Moreover, in this embodiment, a measure for preventing thermal deformation of the shroud ring 101 and the nozzle ring 103 is taken. Thermal deformation means deformation due to a temperature change caused by heat. As described above, the distance between the shroud ring 101 and the nozzle ring 103 is basically kept constant by the coupling pin 119. However, when thermal deformation of the shroud ring 101 and the nozzle ring 103 occurs, the smooth operation of the nozzle vane 113 may be hindered due to, for example, the distance between the shroud ring 101 and the nozzle ring 103 becoming locally narrow. Now, the measure for preventing thermal deformation of the shroud ring 101 and the nozzle ring 103 is described.

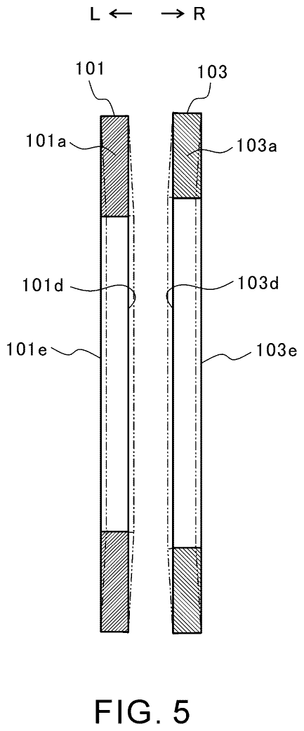

FIG. 5 is an explanatory view for illustrating the thermal deformation of the shroud ring 101 and the nozzle ring 103. In FIG. 5, for ease of understanding, the shapes of the shroud ring 101 and the nozzle ring 103 are shown in a simplified manner. In FIG. 5, the shroud ring 101 and the nozzle ring 103 before thermal deformation are indicated by solid lines, and the shroud ring 101 and the nozzle ring 103 after thermal deformation are indicated by two-dot chain lines.

When the turbocharger TC is in operation, a high-temperature exhaust gas flows between the shroud ring 101 and the nozzle ring 103. Thus, in each of the shroud ring 101 and the nozzle ring 103, a surface in contact with the exhaust gas is heated by the heat of the exhaust gas. Accordingly, in each of the shroud ring 101 and the nozzle ring 103, a temperature of the surface in contact with the exhaust gas becomes higher than temperatures of other portions. For example, a temperature of the first surface 101d on the right side of the shroud ring 101 becomes higher than a temperature of a second surface 101e on the left side of the shroud ring 101. For example, a temperature of the surface 103d on the left side of the nozzle ring 103 becomes higher than a temperature of a surface 103e on the right side of the nozzle ring 103.

When the turbocharger TC is in operation, with the surface in contact with the exhaust gas being heated in each of the shroud ring 101 and the nozzle ring 103 as described above, thermal deformation indicated by the two-dot chain lines in FIG. 5 occurs. Specifically, as indicated by the two-dot chain lines in FIG. 5, the shroud ring 101 and the nozzle ring 103 each warp so as to approach each other on the radially inner side. Such thermal deformation may be a factor that hinders the smooth operation of the nozzle vane 113.

As illustrated in FIG. 4, in this embodiment, in order to prevent the above-mentioned thermal deformation, an annular protruding portion 101f is provided on the shroud ring 101. The annular protruding portion 101f is provided on the inner peripheral side of the second surface 101e of the shroud ring 101 on a side opposite to the first surface 101d. The second surface 101e has an annular shape, similarly to the first surface 101d.

When viewed in the axial direction, the first surface 101d and the second surface 101e overlap each other. That is, an inner diameter of the second surface 101e is identical to an inner diameter of the first surface 101d. However, the inner diameter of the second surface 101e may be free of being strictly identical to the inner diameter of the first surface 101d, and may be different from the inner diameter of the first surface 101d to some extent. An outer diameter of the second surface 101e is identical to an outer diameter of the first surface 101d. However, the outer diameter of the second surface 101e may be free of being strictly identical to the outer diameter of the first surface 101d, and may be different from the outer diameter of the first surface 101d to some extent.

The annular protruding portion 101f has an annular shape extending in the circumferential direction. The annular protruding portion 101f protrudes in the axial direction. Specifically, the annular protruding portion 101f protrudes to the left from the second surface 101e. In the shroud ring 101, a thickness of the annular protruding portion 101f in the axial direction is larger than thicknesses of other portions in the axial direction. The annular protruding portion 101f is formed coaxially with the turbine impeller 17.

In the example of FIG. 4, the annular protruding portion 101f is provided in a range from an inner peripheral edge to a radial center of the second surface 101e. However, the range in which the annular protruding portion 101f is provided in the second surface 101e is not limited to the example of FIG. 4. The provision of the annular protruding portion 101f on the inner peripheral side of the second surface 101e means, for example, that a radial center of the annular protruding portion 101f is located on a radially inner side with respect to the radial center of the second surface 101e.

For example, in the example of FIG. 4, an inner peripheral edge of the annular protruding portion 101f is continuous with an inner peripheral edge of the second surface 101e. However, the inner peripheral edge of the annular protruding portion 101f may be free of being continuous with the inner peripheral edge of the second surface 101e. In this case, for example, a seal member may be provided between a part of the second surface 101e that is on the radially inner side with respect to the annular protruding portion 101f and the turbine housing 5. Further, a protruding portion that protrudes radially inward from the inner peripheral surface of the shroud ring 101 and extends in the circumferential direction may be provided. In this case, a seal member may be provided between the protruding portion and the turbine housing 5.

For example, in the example of FIG. 4, an outer peripheral edge of the annular protruding portion 101f is located near the radial center of the second surface 101e. However, the outer peripheral edge of the annular protruding portion 101f may be located on the radially outer side or the radially inner side with respect to the radial center of the second surface 101e.

As illustrated in FIG. 2, the pin shaft hole 101b is formed on the radially outer side with respect to the annular protruding portion 101f. That is, the outer peripheral edge of the annular protruding portion 101f is located on the radially inner side with respect to the pin shaft hole 101b. However, the outer peripheral edge of the annular protruding portion 101f may be located on the radially outer side with respect to the pin shaft hole 101b.

As described above, in the turbine T, the annular protruding portion 101f that extends in the circumferential direction and protrudes in the axial direction is provided on the inner peripheral side of the second surface 101e, which is on a side opposite to the first surface 101d, of the shroud ring 101 that is an annular member. Thus, the rigidity of the inner peripheral side of the shroud ring 101 can be increased. Accordingly, the thermal deformation in which the shroud ring 101 and the nozzle ring 103 each warp so as to approach each other on the radially inner side, which is the deformation indicated by the two-dot chain lines in FIG. 5, can be prevented. Thus, it is possible to prevent the smooth operation of the nozzle vane 113 from being hindered due to the thermal deformation of the shroud ring 101 and the nozzle ring 103.

From the viewpoint of effectively increasing the rigidity of the inner peripheral side of the shroud ring 101, it is appropriate that the radial position of the annular protruding portion 101f be as close as possible to the inner peripheral edge of the second surface 101e. For example, it is appropriate that the inner peripheral edge of the annular protruding portion 101f be continuous with the inner peripheral edge of the second surface 101e. For example, it is appropriate that the outer peripheral edge of the annular protruding portion 101f be located on the radially inner side with respect to the radial center of the second surface 101e. For example, it is appropriate that the outer peripheral edge of the annular protruding portion 101f be located on the radially inner side with respect to the pin shaft hole 101b.

When a radial width of the annular protruding portion 101f is constant, as the radial position of the annular protruding portion 101f comes closer to the outer peripheral edge of the second surface 101e, the volume of the annular protruding portion 101f becomes larger. Accordingly, also from the viewpoint of preventing that the volume of the annular protruding portion 101f becomes larger, which in turn results in an increase in the size of the shroud ring 101, it is appropriate that the radial position of the annular protruding portion 101f be as close as possible to the inner peripheral edge of the second surface 101e.

In particular, as illustrated in FIG. 4, in the turbine T, the entire area of the bottom surface 101c1 of each of the plurality of blade shaft holes 101c is opposed to the annular protruding portion 101f in the axial direction. That is, when viewed in the axial direction, the entire area of the bottom surface 101c1 of each blade shaft hole 101c overlaps the annular protruding portion 101f. Thus, a wall thickness in the vicinity of the bottom surface 101c1 of each blade shaft hole 101c in the shroud ring 101 can be ensured by the annular protruding portion 101f. Accordingly, it is possible to suppress an increase in the size of the shroud ring 101 as compared to a case in which a part protruding to the left from the second surface 101e is provided separately from the annular protruding portion 101f in order to ensure the wall thickness in the vicinity of the bottom surface 101c1 of each blade shaft hole 101c.

However, at least a part of the area of the bottom surface 101c1 of each blade shaft hole 101c may be free of being opposed to the annular protruding portion 101f in the axial direction. For example, a part of the bottom surface 101c1 of each blade shaft hole 101c may be opposed to the annular protruding portion 101f in the axial direction, while another part of the bottom surface 101c1 of each blade shaft hole 101c may be free of being opposed to the annular protruding portion 101f in the axial direction. For example, the entire area of the bottom surface 101c1 of each blade shaft hole 101c may be free of being opposed to the annular protruding portion 101f in the axial direction.

In particular, as illustrated in FIG. 4, in the turbine T, a thickness D1 of a part, which is on the radially outer side with respect to the annular protruding portion 101f, of the shroud ring 101 that is an annular member is equal to or less than a depth D2 of the blade shaft hole 101c. For example, in the example of FIG. 4, the thickness D1 of the part of the shroud ring 101 that is on the radially outer side with respect to the annular protruding portion 101f is identical to the depth D2 of the blade shaft hole 101c. Accordingly, the amount corresponding to an increase in the volume of the shroud ring 101 due to forming the bottom surface 101c1 of the blade shaft hole 101c with the annular protruding portion 101f can be reduced to an extent of the volume of the annular protruding portion 101f. For example, an increase in the volume of the shroud ring 101 can be reduced as compared to an example in which a through hole into which the blade shaft 113a is allowed to be inserted is formed in an annular member having a constant thickness and a left opening of the through hole is closed by another member. That is, it is possible to prevent that the thickness D1 of the part of the shroud ring 101 that is on the radially outer side with respect to the annular protruding portion 101f becomes larger than an appropriate thickness, which in turn results in an increase in the size of the shroud ring 101.

However, the thickness D1 of the part of the shroud ring 101 that is on the radially outer side with respect to the annular protruding portion 101f may be larger than the depth D2 of the blade shaft hole 101c.

Although the embodiment of the present disclosure has been described above with reference to the attached drawings, needless to say, the present disclosure is not limited to the above-mentioned embodiment. It is obvious that a person skilled in the art can arrive at various alterations or modifications within the scope of claims, and it is naturally understood that those examples also belong to the technical scope of the present disclosure.

In the above, the example in which the turbine T is mounted on the turbocharger TC has been described. However, a device on which the turbine T is mounted may be a device other than the turbocharger TC.

1. A turbine, comprising:
a turbine impeller;
a plurality of nozzle vanes, which are placed on a radially outer side with respect to the turbine impeller so as to be spaced apart from each other in a circumferential direction of the turbine impeller, and are each provided so as to be pivotable about a pivot axis extending along an axial direction of the turbine impeller;
a blade shaft, which protrudes from each of the plurality of nozzle vanes in the axial direction, and is provided so as to be turnable integrally with each of the plurality of nozzle vanes;
an annular member, which extends in the circumferential direction, and is opposed to the plurality of nozzle vanes in the axial direction;
a plurality of blade shaft holes that open in a first surface of the annular member that is opposed to the plurality of nozzle vanes, the plurality of blade shaft holes being formed apart from each other in the circumferential direction, the plurality of blade shaft holes each allowing the blade shaft to be inserted into the blade shaft hole and each having a bottom surface; and
an annular protruding portion that is provided on an inner peripheral side of a second surface of the annular member on a side opposite to the first surface, the annular protruding portion extending in the circumferential direction and protruding in the axial direction.

2. The turbine according to claim 1, wherein an entire area of the bottom surface of each of the plurality of blade shaft holes is opposed to the annular protruding portion in the axial direction.

3. The turbine according to claim 1, wherein a thickness of a part of the annular member on the radially outer side with respect to the annular protruding portion is equal to or less than a depth of each of the plurality of blade shaft holes.

4. A turbocharger, comprising the turbine of claim 1.

5. A turbocharger, comprising the turbine of claim 2.

6. A turbocharger, comprising the turbine of claim 3.
